(19) United States
(12) Patent Application Publication
(10) Pub. No.: US 2013/0049312 A1
(43) Pub. Date: Feb. 28, 2013

(54) Bowling Ball Bag

(71) Applicant: SHIH-WEN PHILIP HOU, New Taipei City (TW)

(72) Inventor: SHIH-WEN PHILIP HOU, New Taipei City (TW)

(21) Appl. No.: 13/217,227

(22) Filed: Aug. 24, 2011

(51) Int. Cl. B62B 1/00

(52) U.S. Cl. 280/47.26

(57) ABSTRACT

A bowling ball bag includes a bag proper loaded on a cart which is equipped with two wheels at its one side, and a yoke extended from the other said thereof. The bag proper is provided with a side pocket in the direction of the yoke of the cart to be developed on the yoke to form a securely supported loading space. The loading space may be used to preserve a spare ball for the player in case of need.

### BACKGROUND OF THE INVENTION

1. Field of the invention

The present invention relates to a bowling ball bag, and more particularly, to a structure of bowling ball bag which is suitable for users to preserve or carry different number of bowling balls conveniently.

2. Description of the Prior Art

The bowling game is one of the ball games with a long history. It is both welcome as an amateur amusement and a professional sport in the international society as well. In all, bowling game is a sport in which the bowling ball is rolled at a row of bowling pins trying to knock down them, and the score obtained will be higher if more pins being knocked down. For gaining higher score, it is a paramount importance to select proper bowling balls. Generally speaking, a heavier ball which has a larger kinetic energy is easier to knock down the pin. On the other hand, a heavier ball is hard to manipulate. Accordingly, selection of balls will be determined by user's physical condition and regular habit. A usual bowling player does not forget to prepare for himself/herself several numbers of balls for the game managing to get a better record.

Since the bowling balls are considerably heavy, a special care must be taken when carrying or storing them so as to protect them not to be damaged due to mutual collision or falling down that might result in hurting the working personal or damaging the surrounding articles. Therefore it is a must to make up a well designed bowling ball bag for carrying or preserving the balls securely.

A conventional bag may allow to accommodate one, two or three balls for carrying with hand or loading on a cart for the convenience of the player's individual need. In such a case, the player has to prepare several extra bags to accommodate the additional balls to meet his/her special requirement. As the bags for one, two, three or four balls are generally not a standard product so it is unable to carry or be loaded on the cart at random. Should it really has been loaded on the cart, it is not practically convenient for the player, and he/she has to put up with the ugly appearance of the equipment. The clever player may not consider to purchase so many different types of bowling ball bags to carry various number of balls to embarrass himself/herself.

Meanwhile, the conventional cart for loading the bowling ball bags is usually very heavy to settle or remove in a narrow space as in the public transportation facilities. In this case one has to carry the bag with hand or on the shoulder that embarrasses the player very much or even causes a bad effect to the playing record.

For these shortcomings noticeable on the prior situation, an improvement is seriously required.

The inventor of the present invention has plunged into this matter for years to studying and rectifying these defects and finally has come up with this movable bowling ball bag as provided in this invention to eliminate the prior defects mentioned above.

### SUMMARY OF THE INVENTION

It is an object of the present invention to provide a bowling ball bag which can freely carry different numbers of balls desired by the player conveniently.

It is another object of the present invention to provide a bowling ball bag with clean and neat appearance to offer a noble feeling for the bowling game.

To achieve the above objects, the bowling ball bag according to the present invention comprises several kinds of bags proper to be loaded on a cart. One of the bags proper has two built-in wheels at its one side, and a stretchable yoke extended from the other side so as to let the user able to remove the bag-proper to a position matching his/her stature. The bag proper is provided with a side bag in the yoke direction for storing regular small accessories, or forming a supported loading space by developing the side bag on the yoke in time of need, the loading space may be allowed to store a spare bowling ball. The bag proper has two auxiliary wheels installed at one end of its bottom part, and an auxiliary yoke is provided at the other end thereof so as to enable the bag proper to be carried alone for use. In case there needs a larger vacant space, the bag proper can be entrained on a specially designed cart on which another spare bag can be loaded to store some balls or other accessories. In this manner the user is allowed to select and combine various kinds of bowling ball carrying bags according to the individual desire to carry different numbers of bowling balls.

### BRIEF DESCRIPTION OF THE DRAWINGS

The accompanying drawings, which are included to provide a further understanding of the invention and incorporated in, and constitute a part of this specification, illustrate embodiments of the invention and together with the description serve to explain the principles of the invention.

FIG. 1 is a perspective view of the present invention.

FIG. 2 is an illustrative view showing use of a side pocket.

FIG. 3 is an illustrative view showing the bag proper is in use alone.

FIG. 4 is an illustrative view showing the bag proper together with its side pocket.

FIG. 5 is an illustrative view showing how to develop and use the vacant space.

FIG. 6 is an illustrative view showing the bag proper with its climbing wheel unit.

FIG. 7 is a perspective view of another kind of bag proper of the present invention.

FIG. 8 is an illustrative view showing the bag proper of FIG. 7 with its side pocket.

FIG. 9 is an illustrative view showing the bag proper of FIG. 7 with its climbing wheel unit.

FIG. 10 is a perspective view showing the bag proper of FIG. 7 is carried alone.

FIG. 11 is a perspective view showing another kind of spare bag.

FIG. 12 is a perspective view showing the bag proper of FIG. 7 with the spare bag of FIG. 11 is loaded on a common cart.

FIG. 13 is a perspective view showing the bag proper and its spare bag shown in FIG. 12 is loaded on the other side of the common cart.

### DETAILED DESCRIPTION OF THE PREFERRED EMBODIMENT

Now, the preferred embodiments of the present invention will be described in detail with reference to the accompanied drawings:

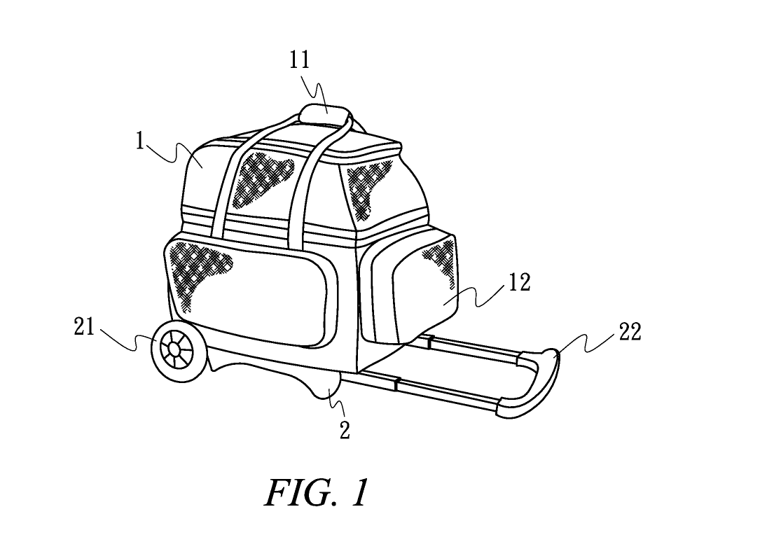

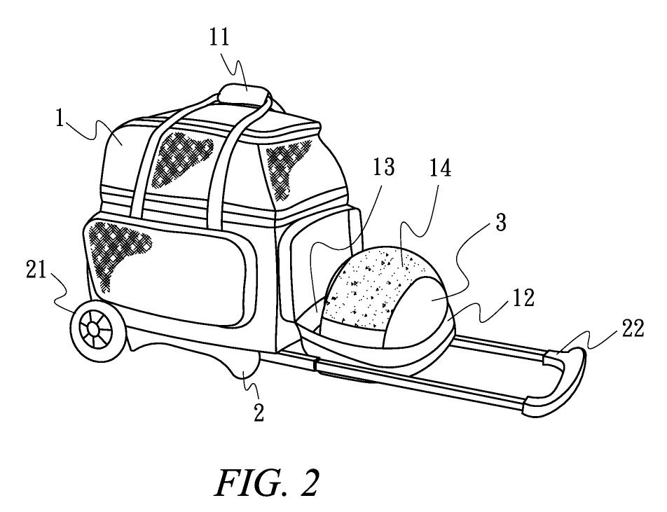

Referring to FIGS. 1 and 2, the bowling ball bag of the present invention comprises a bag proper 1, which is installed on a cart 2. At one side of the cart 2, there are installed two wheels 21 and the other side thereof is a stretchable yoke 22 extended therefrom with a size matching the user's stature for easily removing the bag proper 1. On top of the bag proper 1 there is provided a grip 11 for the user to carry the bag proper 1 with hand.

Since the capacity of the bag proper 1 is limited, the present invention provides a side pocket 12 of the bag proper 1 laid in the direction towards the yoke 22 of the cart 2 to store some small accessories inside. The side pocket 12 may be developed and secured to the yoke 22 to form a supported loading space 13 in case of need for preserving a spare ball 3. The bowling ball 3 kept in the loading space 13 is fastened by a resilient cover 14. There is a resilient cover on the side pocket 12 to attach to the yoke 22 so as to steadily support the bag proper 1.

With this structure, the extra ball in the loading space 13 may provide the player with a better service.

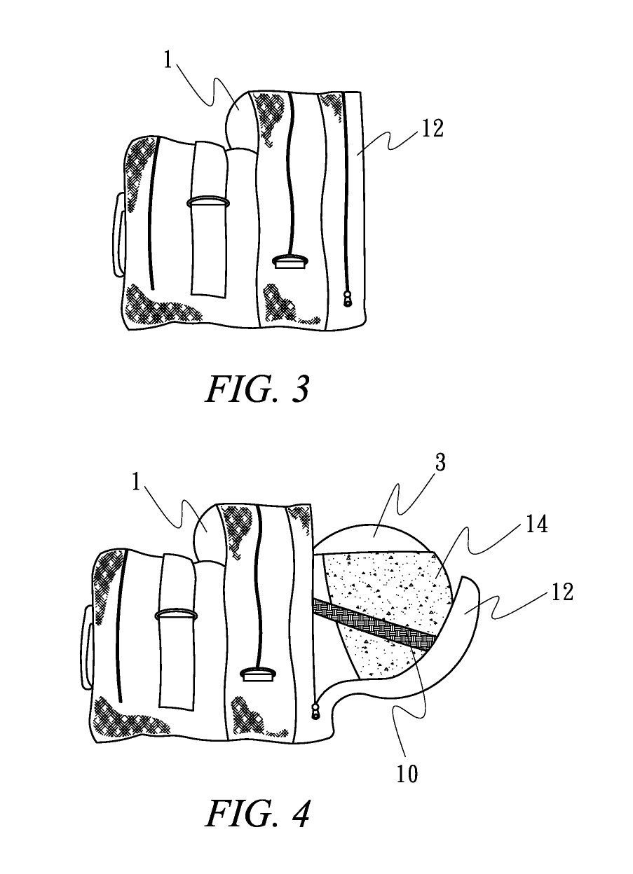

Referring to FIGS. 3 and 4, the bag proper 1 may be used alone. For the remedy to lack of support when the side pocket 12 is developed, a securing band 10 is equipped between the opening of the side pocket 12 and the bag proper 1 so as to hold the ball 3 securely in the loading space.

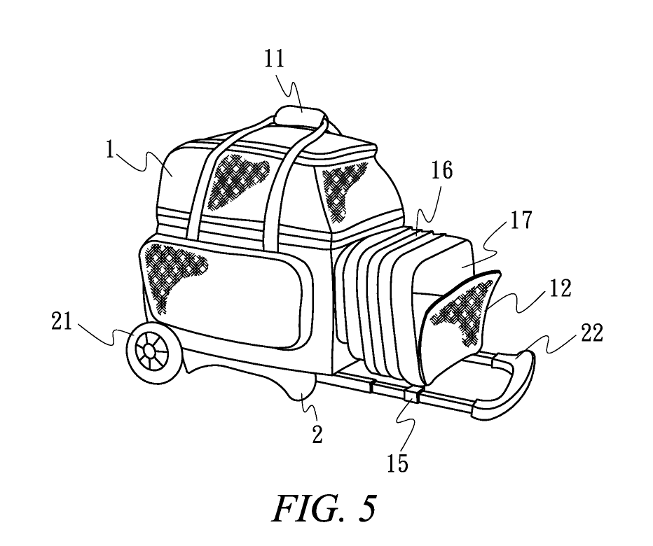

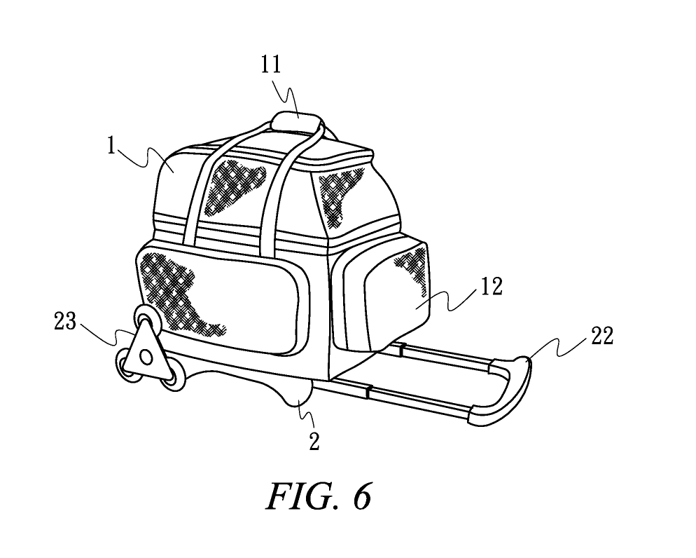

Referring to FIG. 5, the bag proper 1 may be provided with an accordion draws 16 stretchable to form a vacant space 17 inside for accommodating more bowling balls 3 or related accessories. As it is shown in FIG. 6, wheels 21 employed by the present invention are detachable to replace them with a climbing wheel unit 23 composed of three small wheels to climb up the stair case for transporting the bowling balls, or detach the wheels 21 at any time to put the cart including the whole equipment in the baggage container of the public transportation facilities, and afterwards assemble the wheels 21, stretch the yoke 22 again after getting off the vehicle. The cart 2 is foldable by pushing the shrinkable yoke 22 into the cart 2 so as to minimize the size of the cart 2. On the other hand the yoke 22 may be stretched on the cart 2 for carrying the bowling balls.

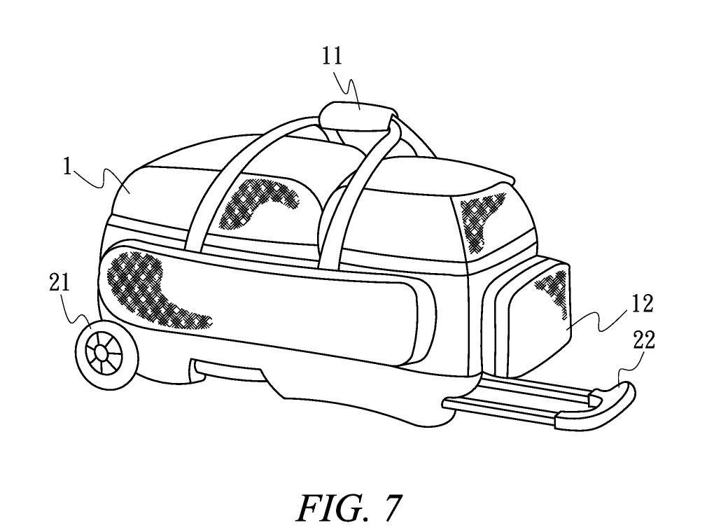

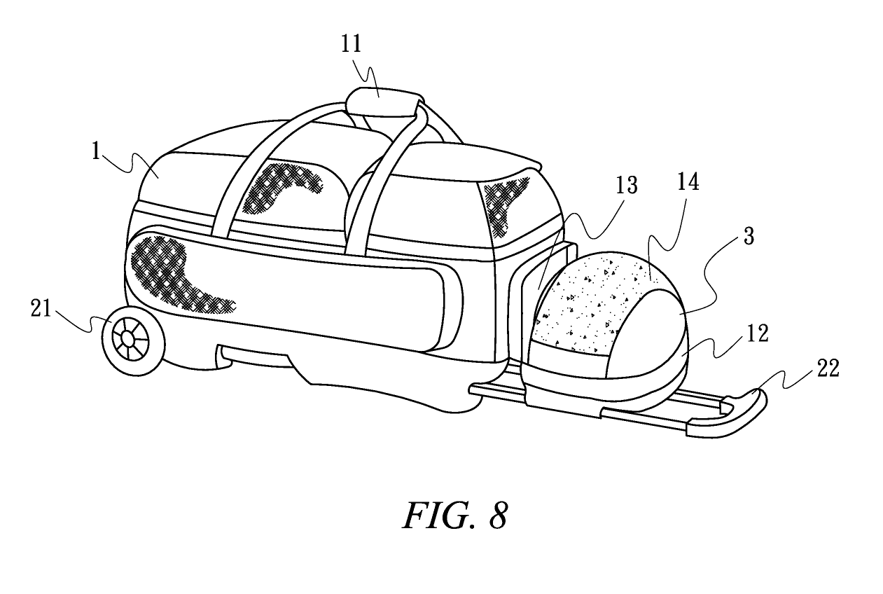

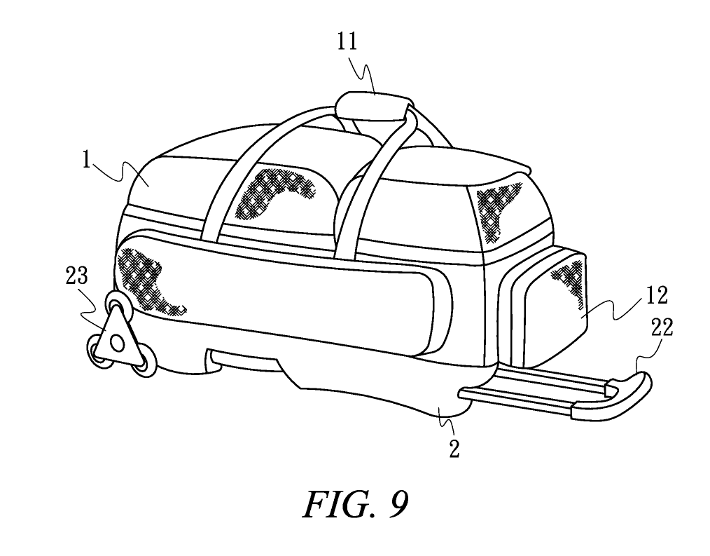

Referring to FIG. 7 through FIG. 9, in another embodiment, the present invention provides a bag proper 1 which has a length different from that of the regular one to accommodate the different number of balls, except the above mentioned difference, other structure is identical with the former one so that it is not necessary to repeat description.

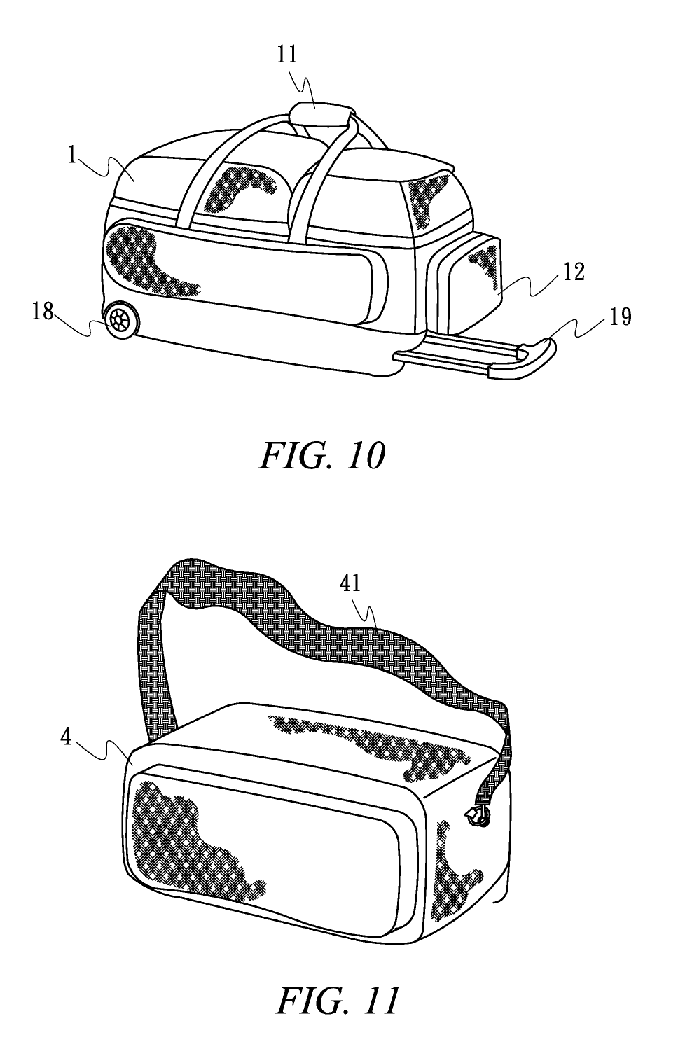

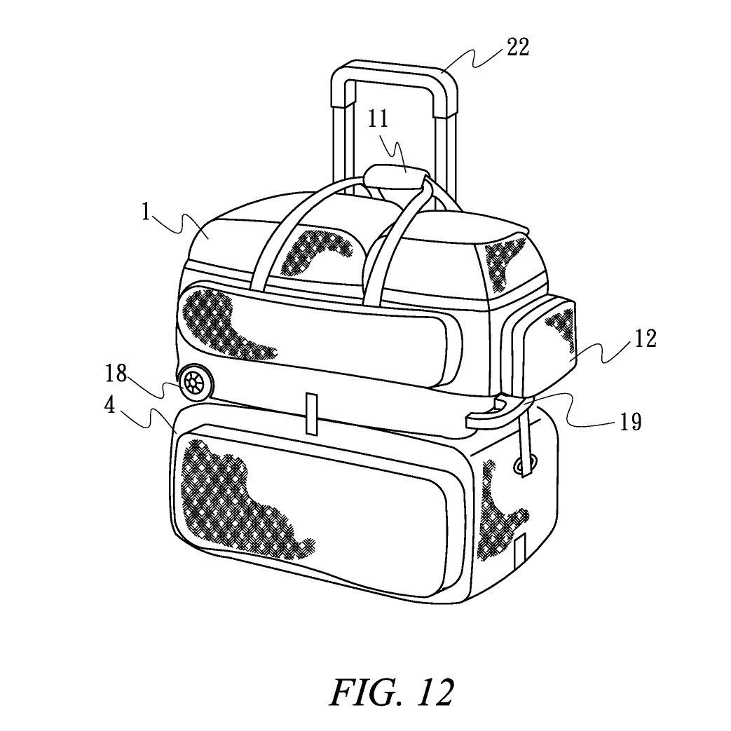

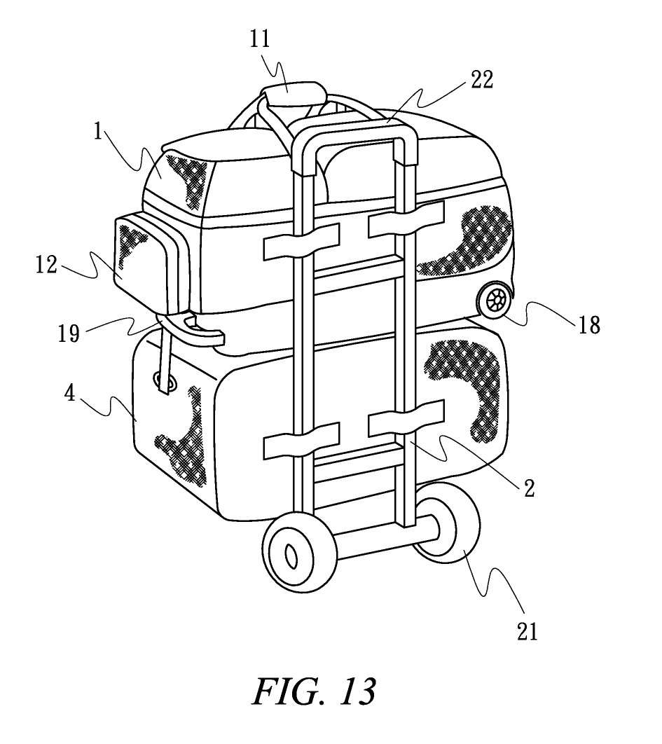

Please referring to FIG. 10 through FIG. 13. For meeting the requirement of users, the present invention provides two built-in auxiliary wheels 18 at one side on the bottom of the bag proper 1, and at the other side thereof is provided with a stretchable auxiliary yoke 19 such that the bag proper 1 can be carried alone. With this structure, it is possible to carry a small numbers of bowling balls 3 along with the bag proper 1 to get on the public transportation facilities and put the whole equipment on the baggage shelf. Similarly, the side pocket 12 of the bag proper 1 is provided in the direction of the auxiliary yoke 19 to form a loading space 13 on the auxiliary yoke 13 after developing the side pocket 12 for loading the spare ball 3. The other components as resilient cover 14 and the ferrules 15 are provided similarly as in the previous example so that the detailed description will not be repeated. In this example the auxiliary wheels 18 can be replaced by the climbing wheel unit 23 as that in the previous case. In case of loading on the public transportation facilities, the auxiliary wheels 23 may be detached and the auxiliary yoke 19 shrank into the bag proper 1 so as to put the whole size minimized equipment on the baggage shelf, and the auxiliary wheels 18 may be installed again and the auxiliary yoke 19 pulled out after getting off the public vehicle.

If a larger storing space is needed, the bag proper 1 still can be loaded on the cart 2, and a spare bag 4 can be prepared on the cart 2 to accommodate various spare balls 3 and other accessories, and then add a carrying band 41 for the user to carry on the shoulder.

The auxiliary wheels 18 are built-in type and flush mounted with the bag proper 1 to save spacing and keep good looking as well. The bag proper 1 and the spare bag 4 can be tightly secured on the cart 2 after the auxiliary yoke 19 is pushed back. The bag proper 1 and the spare bag 4 are secured to the cart 2 by way of binding and fixed by Velcro®. In the present invention, the conventional means such as bolting, stitching or sewing are not employed.

Many changes and modifications in the above described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A bowling ball bag comprising a bag proper installed on a cart, said cart being equipped with two wheels at its one side, and a yoke extended from the other side thereof; wherein
said bag proper is provided with a side pocket in the direction of said yoke of the cart to be developed on said yoke to form a loading space for accommodating a spare ball.

2. The ball bag of claim 1, wherein said loading space is provided with a resilient cover for fastening said bowling ball in said loading space.

3. The ball bag of claim 1, wherein said bag proper has two ferrules each attached to one side of said yoke, or a resilient cover on the side pocket to attach to both sides of said yoke so as to steadily support said bag proper.

4. The ball bag of claim 1, wherein said bag proper is provided with an accordion drawer stretchable to form a vacant space inside for accommodating more bowling balls.

5. The ball bag of claim 1, wherein said wheels of the cart are replaceable with a climbing wheel unit composed of three small wheels.

6. The ball bag of claim 1, wherein said wheels are detachable and said cart is foldable by pushing said yoke into said cart to minimize the size and put said cart including the whole equipment in the baggage container of the public transportation facilities, and afterwards assemble said wheels on said cart and stretch said yoke again after getting off the vehicle.

7. The ball bag of claim 1, wherein when said side pocket of the bag proper is developed, a securing band is equipped between the opening of said side pocket and said bag proper.

8. A bowling ball bag comprising a bag proper, wherein two auxiliary wheels are built in at one side on the bottom of said bag proper, and at the other side thereof is provided with an auxiliary yoke, said bag proper is provided with a side pocket in the direction of said auxiliary yoke to form a loading space on said auxiliary yoke after developing said side pocket for loading a spare ball.

9. The ball bag of claim 8, wherein said loading space is provided with a resilient cover for fastening said bowling ball in said loading space.

10. The ball bag of claim 8, wherein said bag proper has two ferrules each attached to one side of said auxiliary yoke, or a resilient cover on the side pocket to attach to both sides of said yoke so as to steadily support said bag proper.

11. The ball bag of claim 8, wherein said bag proper is provided with an accordion drawer stretchable to form a vacant space inside for accommodation more bowling balls.

12. The ball bag of claim 8, wherein said two auxiliary wheels are built-in type and flush mounted with said bag proper to save spacing and keep good looking

13. The ball bag of claim 8, wherein said bag proper is mounted on said cart after pushing back said auxiliary yoke, and preparing a spare bag for accommodating more bowling balls and accessories.

14. The ball bag of claim 8, wherein said auxiliary wheels of the cart are replaceable with a climbing wheel unit composed of three small wheels.

15. The ball bag of claim 8, wherein said auxiliary wheels are detachable and said cart is foldable by pushing said auxiliary yoke into said bag proper to minimize the size and put said cart including the whole equipment in the baggage container of the public transportation facilities, and afterwards assemble said wheels on said cart and stretch said auxiliary yoke again after getting off the vehicle.
